(19) United States
(12) Patent Application Publication
(10) Pub. No.: US 2019/0091611 A1
(43) Pub. Date: Mar. 28, 2019

(54) FILTER ASSEMBLY FOR SOLENOID-ACTUATED VALVE

(71) Applicant: BorgWarner Inc., Auburn Hills, MI (US)

(72) Inventor: Chandreshwar Rao, Lake Orion, MI (US)

(21) Appl. No.: 16/143,524

(22) Filed: Sep. 27, 2018

Related U.S. Application Data
(60) Provisional application No. 62/564,513, filed on Sep. 28, 2017.

(51) Int. Cl. B01D 29/05; B01D 29/00; F16K 3/26

(52) U.S. Cl. CPC B01D 29/055; F16K 31/0613; F16K 3/26; B01D 29/0011

(57) ABSTRACT

A filter assembly for a solenoid-actuated valve includes a filter band adapted to be disposed about a valve body of the solenoid-actuated valve. The filter band has a first end and a second end. The filter assembly also includes a locking mechanism to lock the first end and the second end together. The locking mechanism includes one of the first end and the second end having a slot extending therein and at least one aperture extending in communication with the slot and another one of the first end and the second end having at least one post to pass through the at least one aperture such that the first end and the second end lock together in a closed position.

### CROSS-REFERENCE TO RELATED APPLICATION

This application claims the benefit of U.S. Provisional Application No. 62/564,513, filed Sep. 28, 2017, which is hereby expressly incorporated herein by reference in its entirety.

### BACKGROUND OF INVENTION

### 1. Field of Invention

The present invention relates generally to solenoid-actuated valves and, more specifically, to a filter assembly for a solenoid-actuated valve used in a transmission.

### 2. Description of the Related Art

Conventional vehicles known in the art typically include an engine having a rotational output that provides a rotational input into a transmission such as an automatic transmission for a powertrain system of the vehicle. The transmission changes the rotational speed and torque generated by an output of the engine through a series of predetermined gearsets to transmit power to one or more wheels of the vehicle, whereby changing between the gearsets enables the vehicle to travel at different vehicle speeds for a given engine speed.

In addition to changing between the gearsets, the automatic transmission is also used to modulate engagement with the engine, whereby the transmission can selectively control engagement with the engine so as to facilitate vehicle operation. By way of example, torque translation between the engine and the automatic transmission is typically interrupted while the vehicle is parked or idling, or when the transmission changes between the gearsets. In conventional automatic transmissions, modulation is achieved via a hydrodynamic device such as a hydraulic torque converter. However, modern automatic transmissions may replace the torque converter with one or more electronically and/or hydraulically actuated clutches (sometimes referred to in the art as a “dual clutch” automatic transmission). Automatic transmissions are typically controlled using hydraulic fluid, and include a pump assembly, one or more hydraulic solenoid-actuated valves, and an electronic controller. The pump assembly provides a source of fluid power to the solenoid-actuated valves which, in turn, are actuated by the controller so as to selectively direct hydraulic fluid throughout the automatic transmission to control modulation of rotational torque generated by the output of the engine. The solenoid-actuated valves are also typically used to control hydraulic fluid for torque translation to change between the gearsets of the automatic transmission, and may also be used to control hydraulic fluid used to cool and/or lubricate various components of the transmission in operation.

A hydraulic portion of the solenoid-actuated valve has a sleeve or valve body with fluid ports for hydraulic fluid flow. The pressurized fluid flows in or out of the valve body depending upon a position of a spool valve or valve member inside a bore of the valve body of the solenoid-actuated valve. During the fluid's course of flow, the fluid carries foreign particles along therewith, and those particles can greatly affect the movement/performance of the valve member if they are not filtered out before the fluid enters into a region of the valve member. Generally, screen filters are used in solenoid-actuated valves to keep the fluid cleaner from debris and those filters are installed around the fluid ports in the valve body and their open ends are locked with some kind of clasp. The existing locking features are not robust enough to withstand radial hydraulic pressure load and tend to open up in use, which is undesired. Thus, there is a need in the art to provide a filter for a solenoid-actuated valve that has a potential to robustly lock open ends of the filter for use in a transmission.

### SUMMARY OF THE INVENTION

The present invention provides a filter assembly for a solenoid-actuated valve including a filter band adapted to be disposed about a valve body of the solenoid-actuated valve. The filter band has a first end and a second end. The filter assembly also includes a locking mechanism to lock the first end and the second end together. The locking mechanism includes one of the first end and the second end having a slot extending therein and at least one aperture extending in communication with the slot and another one of the first end and the second end having at least one post to pass through the at least one aperture such that the first end and the second end lock together in a closed position.

One advantage of the present invention is that a new filter assembly is provided for a solenoid-actuated valve for use in an automatic transmission. Another advantage of the present invention is that the filter assembly includes a filter band and a locking mechanism that has a potential to robustly lock open ends of the filter band. Yet another advantage of the present invention is that the filter assembly includes a filter band and a locking mechanism with a slot and hole configuration that will together restrain possible opening of the filter band. Still another advantage of the present invention is that the filter assembly includes a filter band with one or more pegs on its circumference to restrict an opening movement of the filter band in a valve body of the solenoid-actuated valve.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a cross-sectional view of one embodiment of a solenoid-actuated valve including a filter assembly, according to the present invention.

FIG. 2 is a perspective view of the filter assembly of FIG. 1 illustrating an open position.

FIG. 3 is a perspective view of the filter assembly of FIG. 1 illustrating a closed position.

FIG. 4 is a sectional view of a portion of the filter assembly and solenoid-actuated valve of FIG. 1.

FIG. 5 is a perspective view of another embodiment, according to the present invention, of the filter assembly of FIG. 1 illustrating a closed position.

### DETAILED DESCRIPTION OF THE INVENTION

Referring now to the figures, where like numerals are used to designate like structure unless otherwise indicated, one embodiment of a solenoid-actuated valve 16, according to the present invention, is shown in connection with a transmission (not shown) such as an automatic transmission of a vehicle (not shown). The solenoid-actuated valve 16 includes a valve body 20 having a valve bore 22. The valve bore 22 has a biasing end 24 and an actuating end 26. The valve body 20 also includes multiple fluid ports with at least one inlet port 28 and at least one outlet port 30 adapted to provide fluid communication with a source of pressurized hydraulic fluid (not shown) and a return to the source of pressurized hydraulic fluid such as a pump (not shown).

The solenoid-actuated valve 16 also includes a valve member 32 or a spool valve (i.e., hydraulic control valve) slideably disposed within the valve bore 22 of the valve body 20. The valve member 32 has a plurality of valve elements 34. The valve elements 34 are adapted to control the flow of pressurized hydraulic fluid between the ports 28,30 of the valve body 20. The valve member 32 further includes a biasing end 40 and an actuating end 42. It should be appreciated that the valve member 32 is integral, unitary, and one-piece.

The solenoid-actuated valve 16 further includes a biasing return spring 44 disposed in the valve bore 22 between the biasing end 40 of the valve member 42 and the biasing end 24 of the valve bore 22. The solenoid valve 16 includes an end member 45 disposed in the biasing end 24 of the valve bore 22. It should be appreciated that the end member 45 is fixed to the valve body 20 and the valve member 32 moves axially relative to the valve body 20.

The solenoid-actuated valve 16 also includes an electronically controlled solenoid, generally indicated at 46, for actuating the valve member 32 to control hydraulic fluid pressure between the inlet port 28 and the outlet port 30. The solenoid 46 includes an overmolded component such as a bobbin 48. The solenoid 46 also includes a can or housing 50 enclosing the bobbin 48. The bobbin 48 has a primary electromagnetic coil 52 wound thereon to create a magnetic field when energized. The solenoid 46 also includes a terminal (not shown) for connecting with the electromagnetic coil 52 and to ground (not shown). The coil 52 is made of copper wire. It should be appreciated that the terminal receives a continuous variable, digital control signal from a primary driver (not shown) such as an electronic controller (not shown).

Accordingly, the electromagnetic coil 52 is independently controlled by respective continuous variable, digital control signals from an electronic controller (not shown). The electronic controller is connected to a pair of contacts (not shown) of the terminal that is attached to the housing 50 of the solenoid 46. When engine conditions require clutching of the automatic transmission, the electronic controller inputs a control signal to the solenoid 46 via the contacts and the terminal. The electronic controller automatically controls actuation during automatic shifts. It should be appreciated that the electronic controller could also be used for the vehicle stopped on hills or the like. It should also be appreciated that the electronic controller can function to sense the occurrence of a manual shift and send a signal to the solenoid 46 for actuating the solenoid-actuated valve 16.

The solenoid 46 further includes an internal diameter or channel 56 extending through a longitudinal axis of the bobbin 48. The actuating end 26 of the valve body 20 is disposed in the channel 56. The solenoid 46 also includes a flux tube 58 co-axially disposed within the channel 56. The flux tube 58 is generally cylindrical in shape with a generally circular cross-section. The flux tube 58 may include an end 60 extending radially outward from one end thereof. The flux tube 58 has an aperture 62 extending axially therethrough. The solenoid 46 also includes a pole piece 64. The pole piece 64 is generally cylindrical in shape with a generally circular cross-section. The pole piece 64 may be integral with the flux tube 58. The pole piece 64 has an aperture 68 extending axially therethrough. The solenoid 46 further includes an armature 78 disposed in the aperture 62 of the flux tube 58 and an actuator rod 80 coupled to the armature 78 that extends through the aperture 68 in the pole piece 64. It should be appreciated that the armature 78 slides within the aperture 62 of the flux tube 58 and the actuator rod 80 slides co-axially with the pole piece 64.

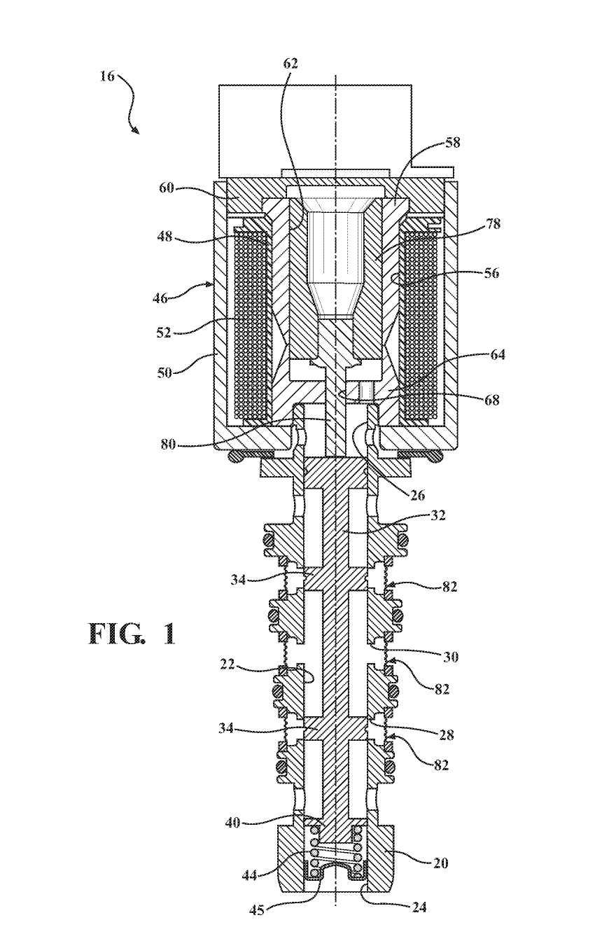

Referring to FIGS. 1-4, the solenoid-actuated valve 16 includes at least one filter assembly, generally indicated at 82 and according to the present invention, disposed about the ports 28, 30 of the valve body 20. In the embodiment illustrated in FIG. 1, a plurality of, for example three, filter assemblies 82 are disposed about the ports 28, 30 of the valve body 20. In one embodiment, the filter assembly 82 includes a filter band 84 adapted to be disposed in a channel about opposed ports 38, 30 of the valve body 20. The filter band 84 is generally arcuate in shape and has a first end 86 at one end and a second end 88 at another end. The filter band 84 is formed from a pair of semi-annular filter band portions 90 and a groove 92 extending axially between the filter band portions 90 to form an integrally-formed hinge between the filter band portions 90. The groove 92 is semi-circular in shape, but may be any suitable shape. One of the filter band portions 90 includes the first end 86 and the other one of the filter band portions 90 includes the second end 88. The filter band 84 is made of a polymer based material. In one embodiment, the polymer based material is a dimensionally stable plastic. The filter band 84 may be formed by injection molding. The filter band 84 may be integral, unitary, and one-piece. It should be appreciated that the groove 92 functions as a hinge that allows relative movement between the first end 86 and the second end 88 of the filter band portions 90.

The filter assembly 82 also includes at least one filter aperture 94 extending radially through and circumferentially along the filter portions 90. In one embodiment, a plurality of, for example two, filter apertures 94 extend through each of the filter portions 90. In one embodiment, the filter apertures 94 are generally rectangular in shape, but may be any suitable shape. The filter assembly 82 includes at least one filter 96 disposed in at least one filter aperture 94. In one embodiment, a plurality of filters 96 are disposed in the filter apertures 94. In one embodiment, one filter 96 is disposed in one filter aperture 94. The filter 96 is made of a filter material. In one embodiment, the filter material is a mesh. The filter material may be secured to the filter band 84 by a suitable mechanism such as an adhesive or by molding of the material for the filter band 84.

The filter assembly 82 further includes a locking mechanism, generally indicated at 98, to lock the first end 86 and the second end 88 of the filter band 84 together. In one embodiment, the locking mechanism 98 includes one of the first end 86 and the second end 88 having a slot 100 extending therein and at least one aperture 102 extending in communication with the slot 100 and another one of the first end 86 and the second end 88 having at least one post 104 to pass through the at least one aperture 102 to lock the first end 86 and the second end 88 together in a closed position. In the embodiment illustrated, the first end 86 has at least one post 104 and the second end 88 has a slot 100 extending therein and at least one aperture 102 extending in communication with the slot 100. The slot 100 extends circumferentially inwardly and axially into the second end 88. The aperture 102 is generally circular in shape, but may be any suitable shape. The first end 86 has a radial thickness less than a radial thickness of the second end 88 such that the first end 86 may be disposed in the slot 100. The post 104 is generally cylindrical in shape with a circular cross-sectional shape, but may be any suitable shape. It should be appreciated that a plurality of apertures 102 and a plurality of posts 104 may be provided with one post 104 being disposed in one aperture 102.

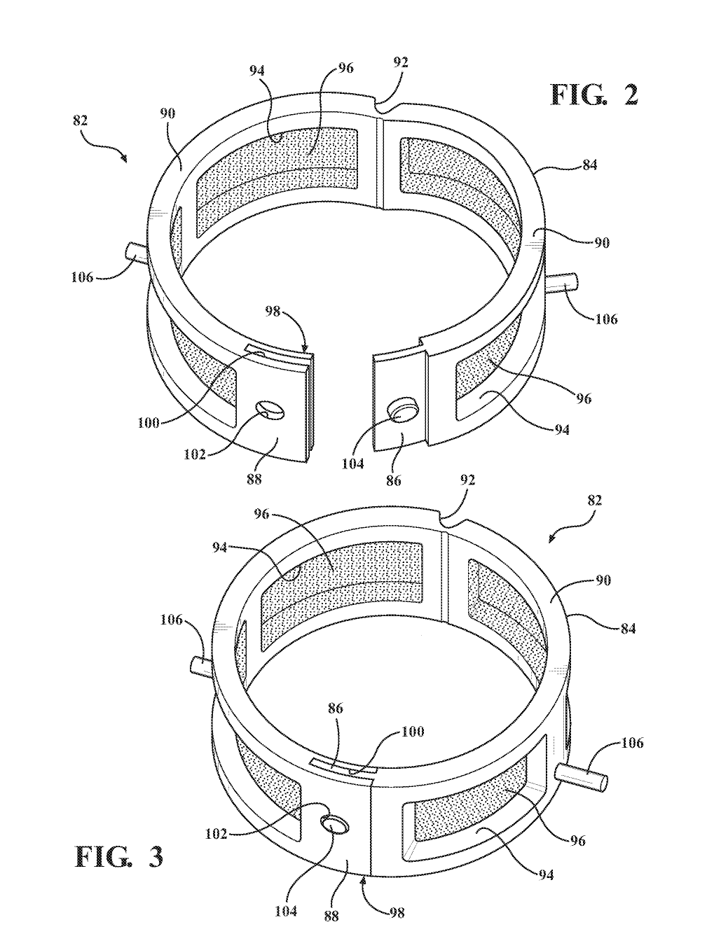

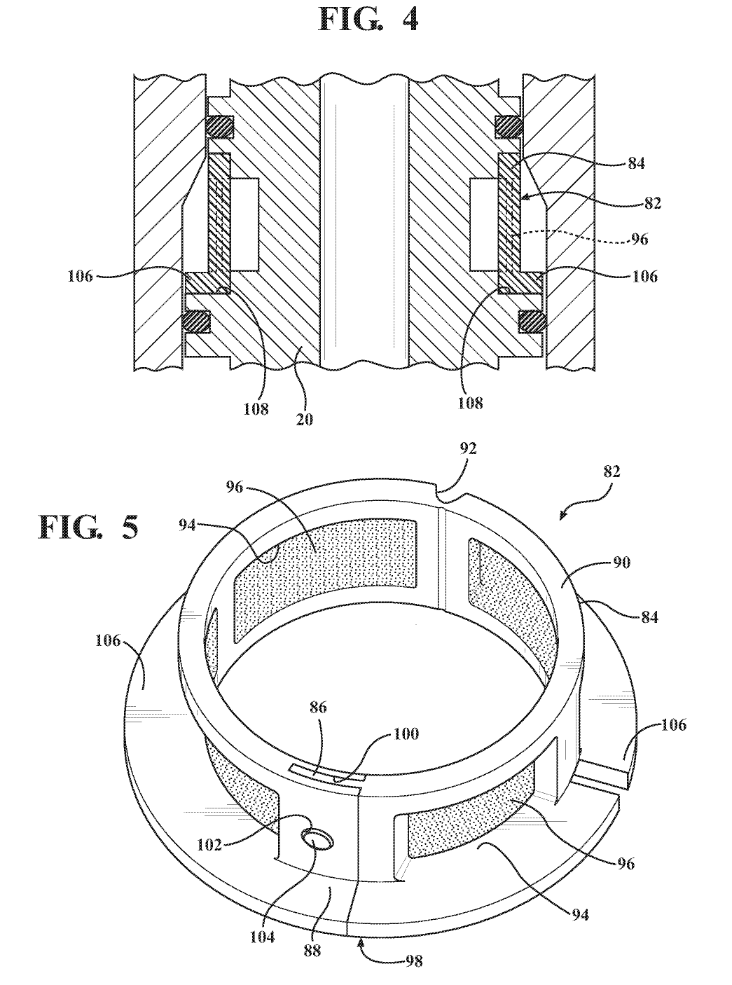

Referring to FIGS. 2-4, the filter assembly 82 may include at least one projection 106 extending radially from a circumference of the filter band 84 to restrict opening movement of the filter band 84 when disposed in a bore around the valve body 20. In one embodiment, the at least one projection 106 is a plurality of pegs are spaced about the circumference of the filter band 84. In one embodiment, a pair of projections 106 are diametrically opposed on the circumference of the filter portions 90. In one embodiment, the projections 106 are generally cylindrical in shape with a circular cross-section, but may be any suitable shape. The projections 106 may be secured to the filter band 84 by a suitable mechanism such as an adhesive or by injection molding of the filter band 84. In another embodiment illustrated in FIG. 5, the at least one projection 106 may be a flange extending radially and circumferentially. In one embodiment, the flange may be continuous or interrupted as a series of flanges. In one embodiment, the flange extends less than three-hundred sixty degrees around the filter band 84 to form a slot or smaller flange and to orientate the filter band 84 relative to the valve body 20. The at least one projection 106 may be made of a plastic material. The at least one projection 106 may be integral, unitary, and one-piece with the filter band 84. The at least one projection 106 may be disposed in at least one corresponding cavity 108 in the valve body 20 to restrict an opening movement of the filter band 84 as illustrated in FIG. 4. It should be appreciated that the at least one projection 106 is optional.

In operation, the filter assembly 82 is installed by opening the locking mechanism 98 and moving the filter portions 90 such that the first end 86 and the second end 88 move away from each other in an open position as illustrated in FIG. 2. The filter portions 90 are placed in the channel 85 over the valve body 20 such that the filter apertures 94 with the filters 96 are located or disposed over the ports 28, 30 in the valve body 20 as illustrated in FIG. 1. The filter portions 90 are moved together such that the first end 86 and the second end 88 move toward each other. The first end 86 is disposed in the slot 100 such that the at least one post 104 is disposed in the at least one aperture 102 to lock the first end 86 and the second end 88 together in the closed position as illustrated in FIG. 3. The projections 106 are located in the cavities 108 of the valve body 20 as illustrated in FIG. 4. It should be appreciated that the locking mechanism 98 may be unlocked to remove the filter assembly 82 from the valve body 20 if desired. It should also be appreciated that the one or more posts 104 and apertures 102 will together constrain any possible opening of the filter band 84 and that a relative large amount of force would be required to break open the filter band 84.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

What is claimed is:

1. A filter assembly for a solenoid-actuated valve, said filter assembly comprising:
a filter band adapted to be disposed about a valve body of the solenoid-actuated valve, said filter band having a first end and a second end; and
a locking mechanism to lock said first end and said second end together, said locking mechanism comprising one of said first end and said second end having a slot extending therein and at least one aperture extending in communication with said slot and another one of said first end and said second end having at least one post to pass through said at least one aperture such that said first end and said second end lock together in a closed position.

2. A filter assembly as set forth in claim 1 including at least one projection extending from said filter band to restrict opening movement in the valve body of the solenoid-actuated valve.

3. A filter assembly as set forth in claim 1 wherein said slot extends circumferentially.

4. A filter assembly as set forth in claim 1 wherein said at least one aperture extends radially therethrough.

5. A filter assembly as set forth in claim 1 wherein said at least one post is generally cylindrical in shape.

6. A filter assembly as set forth in claim 1 wherein said filter band is generally arcuate in shape.

7. A filter assembly as set forth in claim 6 wherein said filter band is formed by a pair of filter portions and a hinge interconnecting said filter portions.

8. A filter assembly as set forth in claim 7 wherein each of said filter portions includes at least one filter aperture.

9. A filter assembly as set forth in claim 8 including a filter disposed in said at least one filter aperture.

10. A filter assembly as set forth in claim 9 wherein said filter comprises a filter material.

11. A filter assembly as set forth in claim 1 wherein said filter band is made of a polymer based material.

12. A filter assembly as set forth in claim 11 wherein said filter band is formed by injection molding.

13. A filter assembly for a solenoid-actuated valve, said filter assembly comprising:
a filter band having a generally arcuate shape and a pair of filter portions hingedly connected together and adapted to be disposed about a valve body of the solenoid-actuated valve, each of said filter portions including at least one filter aperture and a filter disposed in said at least one filter aperture, said filter band having a first end on one of said filter portions and a second end on another of said filter portions;
a locking mechanism to lock said first end and said second end together, said locking mechanism comprising one of said first end and said second end having a slot extending circumferentially therein and at least one aperture extending radially therethrough and in communication with said slot and another one of said first end and said second end having at least one cylindrical post to pass through said at least one aperture such that said first end and said second end lock together in a closed position; and
at least one projection on said filter band to restrict opening movement in the valve body of the solenoid-actuated valve.

14. A solenoid-actuated valve comprising:
a solenoid;
a valve body connected to and operatively associated with said solenoid, said valve body having a valve bore extending axially and a plurality of fluid ports in fluid communication with said valve bore;
a valve member axially and slidingly disposed within said valve bore; and
a filter assembly comprising a filter band disposed about said valve body, said filter band having a first end and a second end, and a locking mechanism to lock said first end and said second end together, said locking mechanism comprising one of said first end and said second end having a slot extending therein and at least one aperture extending in communication with said slot and another one of said first end and said second end having at least one post to pass through said at least one aperture such that said first end and said second end lock together in a closed position.

15. A solenoid-actuated valve as set forth in claim 14 wherein said filter assembly includes at least one projection extending from said filter band to restrict opening movement in said valve body.
